(19) United States
(12) Patent Application Publication
(10) Pub. No.: US 2024/0237646 A1
(43) Pub. Date: Jul. 18, 2024

(54) METHODS OF DECREASING PLANT INJURY AND IMPROVING CROP YIELD

(71) Applicant: AMVAC Chemical Corporation, Newport Beach, CA (US)

(72) Inventors: Peter Porpiglia, Putnam Valley, NY (US); Gregory Armel, Rocky Mount, NC (US); Daniel Kunkel, Plainsboro, NJ (US); Charles Silcox, Lincoln University, PA (US)

(73) Assignee: AMVAC Chemical Corporation, Newport Beach, CA (US)

(21) Appl. No.: 18/413,526

(22) Filed: Jan. 16, 2024

Related U.S. Application Data
(60) Provisional application No. 63/439,354, filed on Jan. 17, 2023.

(51) Int. Cl. A01N 43/16; A01N 37/10; A01N 43/54; A01N 43/653; A01P 21/00

(52) U.S. Cl. CPC A01N 43/16; A01N 37/10; A01N 43/54; A01N 43/653; A01P 21/00

(57) ABSTRACT

Methods of reducing plant injury and/or increasing plant or crop yield are provided. The methods include contacting a plant, plant part, soil, or soilless medium with an HYT plant ameliorant composition and one or more pesticide and/or plant growth regulator, wherein the HYT plant ameliorant and the one or more pesticide and/or plant growth regulator are contacted with the plant, plant part, soil, or soilless medium simultaneously or sequentially.

### CROSS REFERENCE TO RELATED APPLICATIONS

This application claims the benefit of U.S. Provisional Application No. 63/439,354 filed on Jan. 17, 2023, which is incorporated herein by reference in its entirety.

### FIELD

This disclosure relates to methods of decreasing plant injury and improving crop yield, particularly by use of plant ameliorants or formulation excipients.

### BACKGROUND

Pesticides (e.g., herbicides insecticides, fungicides, bactericides, miticides, nematicides, defoliants, fumigants, etc.) and plant growth regulators are used to control pests and to enhance the growth, yield, and overall production value of desirable vegetation in agricultural, horticultural, industrial, and non-crop environments. Pesticides and/or plant growth regulators are generally selective to desirable vegetation for many reasons which may include one or more of the following: 1) genetic manipulation or breeding methods for enhanced resistance/tolerance (GMO and non-GMO); 2) natural mechanisms of resistance including but not limited to insensitive or missing target sites and metabolism, compartmentalization, or exudation of these chemistries; 3) differential application methods or placement selectivity of these chemistries minimizing contact and uptake of these chemistries in desirable vegetation; 4) limiting the use rate of pesticides and plant growth regulators to the smallest dose possible that still controls the desired pest or allows for the desired improvement in plant yield or production that does not harm the desirable vegetation; and 5) the use of safeners and antidotes in mixtures.

Application rates for pesticides and plant growth regulators are recommended to give the desired effects while minimizing potential damage to desirable vegetation. Selectivity to pesticides and/or plant growth regulators can be impacted by many factors including tank mixture components (e.g., adjuvants), soil conditions, rainfall, soil/air temperature, and various environmental factors. To enhance crop selectivity, safeners can be included in the formulations to prevent, mask, or to aid in the recovery from pesticide and/or plant growth regulator damage. Safeners (such as natural or synthetic safeners), while valuable, also have limitations, as some are only effective with specific chemicals or classes of chemistry and the vast majority of these safeners only help with crop response from pesticides and plant growth regulators in monocot crops (such as corn, rice, wheat, sorghum, etc.). One of the rare instances of pesticide safening in a dicot crop is when an organophosphate insecticide (e.g., phorate or disulfoton) is applied in combination with the pro-herbicide clomazone, thereby preventing its conversion to the active form keto-clomazone, making it a beneficial herbicide in cotton. However, most dicot crops lack viable options for mixture additives that will alleviate phytotoxic symptoms from pesticides and plant growth regulators. In fact, no examples exist whereby tank-mix additives can decrease phytotoxicity from pesticides and plant growth regulators across a wide array of desirable dicot and monocot vegetation.

Safeners and antidotes are capable of decreasing the visual symptoms associated phytotoxic responses from pesticides and plant growth regulators, however, they are not always able to negate all the fitness penalties associated with this damage to desirable vegetation. In fact, while the desirable vegetation may visually recover and look normal there are often negative impacts later in the growing season including a loss of yield or product quality. Thus, there remains a need for products that will aid in the prevention or recovery of the phytotoxic effects of many chemical classes of pesticides and plant growth regulators in a broad array of crops (both moncot and dicot crops) while ensuring maximum yield and product quality metrics.

### SUMMARY

Provided herein are methods of reducing plant injury and/or increasing plant or crop yield. The methods include contacting a plant, plant part, soil, or soilless medium with an HYT plant ameliorant composition and one or more pesticide and/or plant growth regulator, wherein the contacting with the HYT plant ameliorant and the one or pesticide and/or plant growth regulator is simultaneous or sequential. In some examples, the one or more pesticide includes one or more herbicide, one or more insecticide, one or more fungicide, one or more bactericide, one or more miticide, and/or one or more nematicide. In some examples, the methods further include contacting the plant, plant part, soil, or soilless medium with one or more additional tank mix additives or formulation components.

In some examples, the HYT plant ameliorant composition includes one or more of chitosan, glucosamine, amino acids, trace elements, proteins, and polysaccharides. In some examples, the HYT plant ameliorant composition includes about 0.01-0.025% w/w chitin, about 0.03-0.045% w/w chitosan, about 0.002-0.005% w/w acetylglucosamine, and about 0.001-0.0025% w/w glucosamine. In one specific example, the HYT plant ameliorant composition is B SURE® (AMVAC Chemical Corporation). In some examples, the plant, plant part, soil, or soilless medium is contacted with the HYT plant ameliorant composition at a rate of about 0.25 to about 20 liters/hectare. In certain examples, the plant, plant part, soil, or soilless medium is contacted with the HYT plant ameliorant about 1 hour to 12 months prior to contacting the plant, plant part, soil, or soilless medium with the one or pesticide and/or plant growth regulator.

### DETAILED DESCRIPTION

### I. Overview of Several Aspects

Provided herein are methods of reducing injury to plants and/or increasing crop yield and/or crop quality. The methods include contacting plants with a plant ameliorant (e.g., “HYT plant ameliorant”) and one or more pesticides and/or plant growth regulators. As used herein, a “plant growth regulator” may in some cases also be referred to as a “plant regulator” or a “growth regulator.” These methods may provide additive or synergistic improvements in one or more of pest control, desirable plant growth and appearance, levels of phytonutrients (e.g., sugars, amino acids, fatty acids, elemental nutrients, proteins, antioxidants/plant pigments (e.g., xanthophyll cycle pigments, carotenoids, chlorophyll, etc.), and/or crop yield or other value-added traits associated with crop yield (e.g., improved size of fruit/grain size, taste or health enhancements, grade quality, improved aesthetic qualities, enhanced ripening/quicker time to harvest, etc.).

In some aspects, the methods include applying one or more pesticides (such as one or more herbicides, fungicides, bactericides, insecticides, miticides, and/or nematicides) or plant growth regulators and a plant ameliorant to a plant, plant part, soil, soilless media, water, or other media or environments where plants grow.

In some aspects, the methods include applying the pesticide or plant growth regulator and the plant ameliorant to the plant simultaneously (for example, as a mixture or combination, for example, in a tank mixture). In other aspects, the methods include applying the one or more pesticides or plant growth regulators and the plant ameliorant to the plant, plant part, soil, soilless media, water, or other media or environments where plants grow sequentially (for example, the one or more or plant growth regulators followed by the plant ameliorant or the plant ameliorant followed by the one or more pesticides or plant growth regulators). The sequential applications of the plant ameliorant and the one or more pesticides or plant growth regulators can be separated by a period of time ranging from approximately 1 hour to approximately 12 months (for example, separated by about 1-24 hours, about 1-7 days, about 1-2 weeks, about 2-4 weeks, about 1-3 months, about 3-6 months, about 6-9 months, or about 9-12 months). The timing of sequential application can be selected by one of ordinary skill in the art, for example, based on the plant or crop, the one or more pesticides or plant growth regulators being used, the location, time of year, and other factors.

The timing and amount of application of the one or more pesticides and/or plant growth regulators can be selected by one of ordinary skill in the art, for example, based on the plant or crop, the one or more pesticides or plant growth regulators being used, the location, time of year, and other factors. In some examples, the one or more pesticides (such as one or more herbicides, fungicides, bactericides, insecticides, miticides, or nematicides), plant growth regulators, and/or the plant ameliorant may be applied to the plant, plant part, soil, soilless media, water, or other media or environments where plants grow one or more times (such as 1, 2, 3, 4, 5, 6, or more times) for example, one or more times per growing season or calendar year.

In some aspects, the simultaneous or sequential application of the plant ameliorant and one or more pesticides and/or plant growth regulators results in a reduction of injury to plants (such as visual injury or other injury) compared to application of the one or more pesticides and/or plant growth regulators in the absence of the plant ameliorant. In some aspects, the reduction in injury is at least about 5% (such as at least about 5%, at least about 10%, at least about 15%, at least about 20%, at least about 25%, at least about 30%, at least about 40%, at least about 50%, at least about 60%, at least about 75%, at least about 80%, at least about 90%, or more) compared to treatment with one or more pesticides and/or plant growth regulators in the absence of the plant ameliorant. In other examples, the simultaneous or sequential application of the plant ameliorant and one or more pesticides and/or plant growth regulators results in an increase in plant biomass accumulation, plant height, measures of plant nutrients, chlorophyll fluorescence, measurements of light reflectance patterns of plant surfaces, transpiration, respiration, photosynthesis, yield, or any other quantitative or qualitative measurements of plant health and vigor of at least about 1% (such as at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 40%, at least about 50%, at least about 60%, at least about 75%, at least about 80%, at least about 90%, or more) compared to treatment with one or more pesticides and/or plant growth regulators in the absence of the plant ameliorant.

In some examples, one or more pesticides and/or plant growth regulators are applied at rates (in amounts) that cause visual injury of between about 1% to about 99% (for example about 2.5% to about 75% or about 5% to about 50%). Visual injury is determined by creating an average percentage of damage that is caused by a combination of stunting, thinning, lodging, defoliation, bleaching, chlorosis, necrosis (burn), root malformation, or other symptomology that occurs to a treated plant following the application of one or more pesticides and/or plant growth regulators that is observable when compared to untreated plants. In other examples, one or more pesticides and/or plant growth regulators may not produce obvious visual injury. In those situations, injury may also be measured with tools used to measure differences in plant biomass accumulation, plant height, measures of plant nutrients, chlorophyll fluorescence, measurements of light reflectance patterns off plant surfaces, transpiration, respiration, photosynthesis, yield, or any other quantitative or qualitative measurements of plant health and vigor.

In some aspects, application of the plant ameliorant prior to, in mixtures with, or following the application of one or more pesticides and/or plant growth regulators may also be used with various ratios of one or more additional components consistent with standard practices in agricultural, horticultural, industrial, and non-crop situations. In some examples, the additives or formulation components include additional agrochemicals of synthetic, natural product, or pesticides derived from biological sources, such as insecticides, fungicides, bactericides, nematicides, herbicides, miticides, defoliants, fumigants, and/or plant growth regulators. In other examples, the additives or formulation components include diluents and/or additives used to create a formulated product. For example, these components may include solid and/or liquid formulated product materials, for example, glycerin, propylene glycols, cellulose, oils, paraffins/waxes, emulsifiers, thickeners, stickers, spreaders, dyes, mineral clays, organic solvents, stabilizing agents, biocides, water, humectants, etc. In additional examples, the additives or formulation components include adjuvants, such as wetters, stickers, non-ionic surfactants, anionic surfactants, seed based or petroleum-based oils, organosilicone surfactants, water conditioning agents, AMS/UAN based additives, etc. In other examples, the additives or formulation components may include fertilizers and other nutrient based additives (such as individual nutrients or mixtures of multiple macronutrients such as nitrogen, potassium, and phosphorous and/or micronutrients such as manganese, magnesium, iron, copper, boron, zinc, etc.) In other examples, additional additives include drift retardants, defoaming agents, dyes, etc. In still further examples, additional additives include crop safeners, such as benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, metcamifen, naphthalic anhydride, oxabetrinil, etc.

In some examples, the methods include applying or contacting desirable vegetation with one or more pesticides (such as one or more herbicides, fungicides, bactericides, insecticides, miticides, or nematicides) or plant growth regulators and a plant ameliorant. Desirable vegetation can be described as any row crop, vegetable crop, fruit crop, plantation crop, forest tree/shrub/vine/forb, ornamental/landscape plants, turf, pasture, herbs and rangeland plants, aquatic vegetation, Christmas trees, including greenhouse and growth chamber grown plants, and any naturally growing plants in native environments. Crops or plants include but are not limited to alfalfa, corn (maize), sweet corn, popcorn, hemp, sorghum, millet, milo, cotton, soybean, edamame, sugarbeet, sugarcane, safflower, sunflower, canola, rape, peanut, rice, barley, oat, triticale, rye, wheat, agave, potato, flax, tobacco, mushrooms, fruit (e.g., apple, apricot, avocado, banana, blackberry, raspberry, loganberry, blackcurrant, blueberry, cherry, cranberry, fig, orange, grapefruit, lemon, lime, mandarin, clementine, tangerine, olive, grape, guava, kiwi, mango, nectarine, papaya, peach, pear, persimmon, pineapple, plum, pomegranate, quince, strawberry, tomato, eggplant, pepper, melon, cucumber, watermelon, pumpkin, squash, zucchini, cantaloupe, honeydew, etc.), nuts (e.g., almond, beech, butternut, brazil nut, candlenut, cashew, chestnuts, filbert, hickory, kola nut, pecan, macadamia, maya nut, paradise nut, pili nut, pistachio, walnut, etc.), edible legumes and vegetables (e.g., asparagus, artichoke, collard greens, mustard greens, celery, kale, leafy greens, lettuce, chickpea, snapbean, lima bean, cabbage, dry bean, dry pea, pea, lentil, radish, rhubarb, spinach, onion, garlic, carrot, broccoli, cauliflower, sweet potato, turnip, etc.), turfgrass (e.g., fescue, bentgrass, Kentucky bluegrass, zoysiagrass, centipedegrass, bermudagrass, St. Augustinegrass, etc.), forage grasses (e.g., foxtail, fescue, oatgrass, gamagrass, brome grass, wheatgrass, love grass, Kikuyu grass, Canary grass, centipedegrass, bermudagrass, signalgrass, gambagrass, bluegrass, buffalograss, Timothy, orchardgrass, etc.), forage legumes (e.g., clovers, pigeon pea, centro, calopo, vetch, lupin, acacia, trefoil, lesepedeza, etc.), ornamental plants (e.g., various woody, herbaceous, perennial, biennial, and annual flowers, bulbs, vines, shrubs, trees, and groundcovers to name a few), forest plants (e.g., pines, hardwood trees, shrubs, vines, forbs, wild flowers, etc.), herbs or other scent/flavor enhancing crops (e.g., peppermint, spearmint, chicory, clove, ginger, horseradish, lavender, liquorice, cinnamon, thyme, basil, nutmeg, sesame, vanilla, etc.), and plantation crops (e.g., oil palm, cocoa, coffee, tea, hops, pineapple, hevea, rubber, eucalyptus, coconut, arecanut, etc.).

In some aspects, plants may include genetically modified plants (created by means of plastid, vector, bolistic, CRISPR or other methods of changing or incorporating genetic material into the plant for pesticide and/or plant growth regulator tolerance, pest tolerance, stress tolerance, or any other improvement in plant adaptation to its environment). In other examples, plants may include those that are not genetically modified plants. In addition, plants may also include those plants not considered a genetically modified organism that may or may not have enhanced pesticide and/or plant growth regulator tolerance or other improvements through forced mutation and/or conventional plant breeding techniques.

### II. Plant Ameliorant Composition

The methods provided herein include applying or contacting plants, plant parts, soil, soilless media, water, or other media or environments where plants grow with a plant ameliorant. In some aspects, the plant ameliorant is referred to as “HYT plant ameliorant” or “HYTB.” In additional aspects, the plant ameliorant includes the product B Sure® (AMVAC Chemical Corporation).

In some aspects, the HYT plant ameliorant includes 0.5% total nitrogen and 0.5% soluble potash (K₂O). The HYT plant ameliorant also includes chitin, chitosan, acetylglucosamine, and glucosamine. In certain examples, the HYT plant ameliorant includes about 0.01-0.025% w/w chitin, about 0.03-0.045% w/w chitosan, about 0.002-0.005% w/w acetylglucosamine, and about 0.001-0.0025% w/w glucosamine.

In some examples, the HYT plant ameliorant may also include other polysaccharides, protein or amino acids, and other trace elements. In some examples, the HYT plant ameliorant is a liquid. In other examples, the HYT plant ameliorant is a solid (for example, a dried form of the liquid composition) and may be reconstituted with water or other liquids (e.g., liquid fertilizers) prior to use.

In some aspects, the HYT plant ameliorant is produced by the biodegradation of chitin-containing biological material (for example, aquatic animals or aquatic animal by-products, insects, or fungi) with a microbial composition or consortium. In some examples, the HYT plant ameliorant is produced by mixing one or more of microbial compositions with a chitin-containing biological material to form a mixture, fermenting the mixture, and separating the mixture into solid, aqueous, and optionally, lipid fractions. In non-limiting examples, the microbial composition includes one or more compositions described in any one of U.S. Pat. Nos. 8,748,124; 10,932,470; 11,066,341; 11,230,505; and 11,230,506 and/or any one of U.S. Pat. Publication Nos. 2012/0084886 and 2019/0183131.

Chitin-containing biological materials include, but are not limited to, aquatic animals or aquatic animal by-products, insects, and fungi. In some examples, the chitin-containing biological material is an aquatic animal, such as an aquatic arthropod (for example, a member of Class Malacostraca). Aquatic arthropods for use in the disclosed methods include shrimp, crab, lobster, crayfish, and krill. In some examples, the entire aquatic animal (such as an aquatic arthropod) or aquatic animal by-products are used in the biodegradation methods disclosed herein. Aquatic animal by-products include any part of an aquatic animal, such as any part produced by processing of the aquatic animal. In some examples, an aquatic animal by-product is all or a portion of an aquatic animal exoskeleton, such as shrimp, crab, crayfish, or lobster shell. In other examples, an aquatic animal by-product is a part of an aquatic animal, for example, shrimp cephalothoraxes.

In other examples, the chitin-containing biological material includes fungi, such as fungi from Phylum Zygomycota, Basidiomycota, Ascomycota, or Deuteromycota. Particular exemplary fungi include Aspergillus spp., Penicillium spp., Trichoderma spp., Saccharomyces spp., and Schizosaccharomyces spp. Thus, baker, brewer, and distiller waste streams can provide sources for chitin-containing biological material. In still further examples, the chitin-containing biological material includes insects that contain chitin in their exoskeletons, such as grasshoppers, crickets, beetles, and other insects. Byproducts of the processing of such insects are also contemplated to be sources of chitin.

The chitin-containing biological material is mixed with a microbial composition (such as a composition described above) to form a substantially homogeneous mixture. In some examples, the chitin-containing biological material is ground, crushed, minced, milled, or otherwise dispersed prior to mixing with the microbial composition described herein. In particular examples, the mixture contains about 10-50% (such as about 10-20%, about 20-30%, about 30-40%, about 25-40%, for example about 25%, about 30%, about 35%, about 40%, about 45%, or about 50%) chitin-containing material (such as shrimp heads) (w/v) in inoculum containing about 0.1-5% (such as about 0.1-1%, about 0.5-2%, about 1-2%, about 2-3%, about 0.1%, about 0.2%, about 0.3%, about 0.5%, about 0.8%, about 1%, about 1.25%, about 1.5%, about 1.75%, about 2%, about 2.5%, about 3%, about 4%, or about 5%) of the microbial composition (v/v).

In some examples, the inoculum, chitin-containing biological material, and a sugar (or other carbon source) are mixed together, for example by stirring or agitation. In other examples, one or more of the microbes in the microbial composition is optionally activated prior to mixing with the chitin-containing biological material and fermentation. Activation is not required for the methods disclosed herein. Adjustments to the time and/or temperature of the fermentation can be made by one of skill in the art, depending on whether the microbes are activated prior to fermentation. Activation of the microbe(s) can be by incubating an inoculum of the microbial composition with a carbon source (such as a sugar, for example, glucose, sucrose, fructose, or other sugar) at a temperature and for a sufficient period of time for the microbes to grow. In some examples, an inoculum of the microbes (such as a microbial composition described herein) has a concentration of about 0.05-5% v/v (for example, about 0.5-5%, about 0.5-2%, about 1-2%, or about 2-3%) in a liquid medium. The inoculum is diluted in a solution containing about 0.1-1% sugar (for example, about 0.1-0.5%, about 0.1-0.3%, about 0.2-0.6%, or about 0.5-1%, such as about 0.1%, about 0.2%, about 0.3%, about 0.4%, about 0.5%, about 0.6%, about 0.7%, about 0.8%, about 0.9%, or about 1%) and incubated at ambient temperatures, for example about 20-40° C. (such as about 20° C., about 25° C., about 30° ° C., about 35° C., or about 40° C.) for about 1-5 days (such as about 24 hours, about 48 hours, about 72 hours, about 96 hours, or about 120 hours). In other examples, activation of the microbe(s) can be activated by incubating an inoculum of the microbial composition at a temperature and for a sufficient period of time for the microbes to grow, for example, incubation at about 20-40° C. (such as about 25-35° C.) for 12 hours to 5 days (such as 1-4 days or 2-3 days). In some non-limiting examples, the microbes are considered to be activated when the culture reaches an optical density of >0.005 at 600 nm.

After mixing the chitin-containing biological material and the microbial composition (which is optionally activated), the mixture is fermented. In some examples, the pH of the mixture is measured prior to fermentation. The pH is adjusted to a selected range (e.g., pH about 3 to about 4 or about 3.5 to 4), if necessary, prior to fermentation. The mixture is incubated at a temperature of about 20-40° C. (for example, about 30°−36° C., such as about 30° ° C., about 31° C., about 32° C., about 33° ° C., about 34° C., about 35° C., about 36° ° C., about 37° C., about 38° C., about 39° C., or about 40° C.) for about 1-30 days (such as about 3-28 days, about 7-21 days, about 3, 5, 7, 10, 14, 16, 20, 24, 28, or 30 days). The mixture is agitated periodically (for example, non-continuous agitation). In some examples, the mixture is agitated for a period of time every 1-7 days, for example every 1, 2, 3, 4, 5, 6, or 7 days. In some non-limiting examples, the fermentation proceeds until the titratable acidity (TTA) is about 3-5% and the pH is about 4-5.

Following the fermentation, the resulting fermented mixture is separated into at least solid and liquid fractions. In some examples, the liquid fraction is the HYT plant ameliorant, or HYTB. In some examples, the fermentation is passed from the tank to settling equipment. The liquid is subsequently decanted and centrifuged. In one non-limiting example, the fermented mixture is centrifuged at 1250 rpm (930×g) for 15 minutes at about 5° ° C. to obtain liquid and lipid (e.g., pigment) fractions. The liquid (or aqueous) fraction obtained from the biodegradation process can be stored at ambient temperature. In some non-limiting examples, a sugar is added to the liquid fraction, for example at 1-10% v/v.

The liquid fraction may include components such as protein, amino acids, glucosamine, trace elements (such as calcium, magnesium, zinc, copper, iron, and/or manganese), and/or enzymes (such as lactic enzymes, proteases, lipases, and/or chitinases). In some non-limiting examples, the liquid fraction contains (w/v) about 1-5% total amino acids (such as about 1-3%, about 2-4%, or about 3-5% total amino acids), about 3-10% protein (such as about 3-6%, about 4-7%, about 5-8%, about 6-9%, or about 7-10% protein), about 0.5-2% nitrogen (such as about 0.5-1%, about 0.75-1.25%, about 1-1.5%, or about 1.5-2% nitrogen), less than about 0.2% phosphorus, about 0.5-1% potassium, about 4-8% carbon (such as about 4-6%, about 5-7%, or about 6-8% carbon), about 0.2-1% calcium (such as about 0.2-0.5%, about 0.4-0.8%, or about 0.7-1% calcium), less than about 0.2% magnesium, less than about 0.2% sodium, and/or about 0.1-0.4% sulfur (such as about 0.1-0.3% or about 0.2-0.4% sulfur). In additional non-limiting examples, the liquid fraction includes about 0.001-0.01% glucosamine (for example, about 0.005% or less, about 0.002% or less, or about 0.001% or less). The liquid fraction also may contain one or more microbes (e.g., from the inoculum used to start the fermentation process) and/or trace amounts of chitosan or chitin.

In some aspects, the HYT plant ameliorant is applied at a rate of about 0.25 to about 20 liters/hectare (for example, about 0.25 liters/hectare to about 1 liter/hectare, about 0.5 liters/hectare to about 10 liters/hectare, about 1 liter/hectare to about 3 liters/hectare, about 2.5 liters/hectare to about 12.5 liters/hectare, about 10 liters/hectare to about 15 liters/hectare, or about 15 liters/hectare to about 20 liters/hectare) in a tank mix or as a premix formulation with one or more pesticides and/or plant growth regulators or in multiple applications. In some examples, the HYT plant ameliorant is applied to the soil, water (in flood irrigation or through other irrigation methods), or on various parts of plants, roots, plant cuttings, grafts, fruiting bodies, or seeds prior to or in combination with the one or more pesticides and/or plant growth regulators. In other examples, the HYT plant ameliorant is applied prior to, or as a remedial treatment following the application of one or more pesticides and/or plant growth regulators. Multiple applications of the HYT plant ameliorant may be applied prior to, in combination with, or following the application of multiple or single active ingredient applications of pesticides and/or plant growth regulators.

In some examples, the methods provided herein permit increased rates of application of pesticides or plant growth regulators than in the absence of the application of the HYT plant ameliorant, while reducing or maintaining levels of plant injury and/or increasing or maintaining crop yield or productivity.

### III. Combination with Herbicides

In some aspects, the methods provided herein include application of a plant ameliorant (“HYT plant ameliorant”) to plants in combination with one or more herbicides (e.g., 1, 2, 3, 4, or more herbicides) either simultaneously or sequentially.

This application may be further in combination with or without diluents, adjuvants, fertilizers, nutrient based additives, crop safeners, other pesticides and/or plant growth regulators, and/or other additives. Information on herbicide classifications can be found at the Herbicide Resistance Action Committee website (hracglobal.com/tools/). Herbicides include salts, esters, pro-herbicide variations, dimers, conjugates, and formulated versions of herbicide actives, such as those listed below.

In some examples, herbicides include inhibitors of acetyl CoA carboxylase (ACCase), such as Alloxydim, Butroxydim, Clethodim, Cloproxydim, Cycloxydim, Profoxydim, Sethoxydim, Tepraloxydim, Tralkoxydim, Clodinafop, Clofop, Cyhalofop, Diclofop, Fenoxaprop, Fenthiaprop, Fluazifop, Haloxyfop, Isoxapyrifop, Metamifop, Quizalofop, and Pinoxaden, and other inhibitors of ACCase known to one of ordinary skill in the art.

In other examples, herbicides include inhibitors of acetolactase synthase (ALS), such as Bispyribac, Pyribenzoxim, Pyriftalid, Pyriminobac, Pyrithiobac, Pyrimisulfan, Triafamone, Cloransulam, Diclosulam, Florasulam, Flumetsulam, Metosulam, Penoxsulam, Pyroxsulam, Amidosulfuron, Azimsulfuron, Bensulfuron, Chlorimuron, Chlorsulfuron, Cinosulfuron, Cyclosulfamuron, Ethametsulfuron, Ethoxysulfuron, Flazasulfuron, Flucetosulfuron, Flupyrsulfuron, Foramsulfuron, Halosulfuron, Imazosulfuron, Iodosulfuron, Mesosulfuron, Metazosulfuron, Metsulfuron, Nicosulfuron, Orthosulfamuron, Oxasulfuron, Primisulfuron, Propyrisulfuron, Prosulfuron, Pyrazosulfuron, Rimsulfuron, Sulfometuron, Sulfosulfuron, Triasulfuron, Tribenuron, Thifensulfuron, Trifloxysulfuron, Triflusulfuron, Tritosulfuron, Imazamethabenz-methyl, Imazamox, Imazapic, Imazapyr, Imazaquin, Imazethapyr, Flucarbazone, Propoxycarbazone, Thiencarbazone-methyl, and other inhibitors of ALS known to one of ordinary skill in the art.

In further examples, herbicides include inhibitors of photosynthesis. Inhibitors of photosynthesis include but are not limited to compounds that bind to the Qb binding niche of the D1 protein. Exemplary inhibitors of photosynthesis include Atraton, Atrazine, Ametryne, Aziprotryne/Aziprotryn, Chlorazine, CP 17029, Cyanazine, Cyprazine, Desmetryne, Dimethametryn, Dipropetryn, Eglinazine, Ipazine, Methoprotryne/Methoprotryn, Procyazine, Proglinazine, Prometon, Prometryne, Propazine, Sebuthylazine, Secbumeton, Simetryne, Simazine, Terbumeton, Terbuthylazine, Terbutryne, Trictazine, Amicarbazone, Ethiozin, Hexazinone, Isomethiozin, Metamitron, Metribuzin, Bromacil, Isocil, Lenacil, Terbacil, Chlorprocarb, Desmedipham, Phenisopham, Phenmedipham, Chloridazon/Pyrazon, Brompyrazon, Benzthiazuron, Bromuron, Buturon, Chlorbromuron, Chlorotoluron, Chloroxuron, Difenoxuron, Dimefuron, Diuron, Ethidimuron, Fenuron, Fluometuron, Fluothiuron, Isoproturon, Isouron, Linuron, Metobenzuron, Metobromuron, Methabenzthiazuron, Metoxuron, Monolinuron, Monuron, Neburon, Parafluron, Siduron, Tebuthiuron, Thiazafluron, Chloranocryl/Dicryl, Pentanochlor, Propanil, Bromofenoxim, Bromoxynil, loxynil, Pyridate, Bentazon, and other inhibitors of photosynthesis known to one of ordinary skill in the art.

In additional examples, herbicides include protoporphyrinogen oxidase (PROTOX) inhibitors, such as Lactofen, Acifluorfen, Bifenox, Chlornitrofen, Fomesafen, Fluorodifen, Fluoroglycofen, Fluoronitrofen, Nitrofen, Oxyfluorfen, Chlomethoxyfen, Pyraflufen, Oxadiargyl, Oxadiazon, Azafenidin, Carfentrazone, Sulfentrazone, Fluthiacet, Butafenacil, Saflufenacil, Pentoxazone, Chlorphthalim, Cinidon, Flumiclorac, Flumioxazin, Flumipropyn, Trifludimoxazin, Tiafenacil, Pyraclonil, and other PROTOX inhibitors known to one of ordinary skill in the art.

In other examples, herbicides include photosystem I electron diverters (PS1 inhibitors), such as Cyperquat, Diquat, Morfamquat, Paraquat, and other inhibitors of PS1 known to one of ordinary skill in the art.

In further examples, herbicides include inhibitors of p-hydroxyphenylpyruvate dioxygenase (HPPD), such as Mesotrione, Sulcotrione, Tembotrione, Tefuryltrione, Bicyclopyrone, Fenquinotrione, Benzobicyclone, Benzofenap, Pyrasulfotole, Topramezone, Pyrazolynate, Pyrazoxyfen, Tolpyralate, Isoxachlortole, Isoxaflutole, and other inhibitors of HPPD known to one of ordinary skill in the art.

In additional examples, herbicides include inhibitors of phytoene desaturase (PDS), such as Beflubutamid, Diflufenican, Picolinafen, Flurochloridone, Norflurazon, Fluridone, Flurtamone, and other inhibitors of PDS known to one of ordinary skill in the art.

In other examples, herbicides include inhibitors of homogentisate solanesyltransferase (HST), such as Cyclopyrimorate and other inhibitors of HST known to one of ordinary skill in the art.

In further examples, herbicides include inhibitors of deoxy-D-xyulose phosphate synthase (DOXP synthase), such as Bixlozone, Clomazone, and other inhibitors of DOXP synthase known to one of ordinary skill in the art.

In additional examples, herbicides include inhibitors of enolpyruvyl shikimate phosphate synthase (EPSP synthase), such as Glyphosate, Sulfosate, and other inhibitors of EPSP synthase known to one of ordinary skill in the art.

In further examples, herbicides include inhibitors of glutamine synthetase (GS), such as Glufosinate, Bialaphos/Bilanafos, and other inhibitors of GS known to one of ordinary skill in the art.

In other examples, herbicides include inhibitors of dihydropteroate synthase (DS), such as Asulam and other inhibitors of DS known to one of ordinary skill in the art.

In additional examples, herbicides include inhibitors of mitosis, microtubule assembly, or microtubule organization, such as Benefin/Benfluralin, Butralin, Dinitramine, Ethalfluralin, Fluchloralin, Isopropalin, Nitralin, Prodiamine, Profluralin, Oryzalin, Pendimethalin, Trifluralin, Dithiopyr, Thiazopyr, Butamifos, DMPA, Chlorthal/DCPA, Propyzamide/Pronamide, Barban, Carbetamide, Chlorbufam, Chlorpropham, Propham, Swep, and other inhibitors of mitosis known to one of ordinary skill in the art.

In further examples, herbicides include inhibitors of cellulose synthesis (such as inhibitors of cellulose synthase), for example, Flupoxam, Isoxaben, Triaziflam, Indaziflam, Dichlobenil, Chlorthiamid, Quinclorac and other inhibitors of cellulose synthesis known to one of ordinary skill in the art.

In other examples, herbicides include oxidative phosphorylation uncouplers (Oxphos uncouplers), such as Dinosam, Dinoseb, DNOC, Dinoterb, Etinofen, Medinoterb, and other oxphos uncouplers known to one of ordinary skill in the art.

In additional examples, herbicides include inhibitors of very long chain fatty acid synthesis (VLCFA inhibitors), such as scientificlachlor, Allidochlor/CDAA, Butachlor, Butenachlor, Delachlor, Diethatyl, Dimethachlor, Dimethenamid, Metazachlor, Metolachlor, Pethoxamid, Pretilachlor, Propachlor, Propisochlor, Prynachlor, Thenylchlor, Mefenacet, Flufenacet, Butylate, Cycloate, Dimepiperate, EPTC, Esprocarb, Molinate, Orbencarb, Pebulate, Prosulfocarb, Thiobencarb/Benthiocarb, Tiocarbazil, Tri-allate, Vernolate, Benfuresate, Ethofumesate, and other VLCFA inhibitors known to one of ordinary skill in the art.

In other examples, herbicides include auxin mimics and/or auxin transport inhibitors, such as Picloram, Clopyralid, Aminopyralid, Halauxifen, Florpyrauxifen, Triclopyr, Fluroxypyr, 2,4,5-T, 2,4-D, 2,4-DB, Clomeprop, Dichlorprop, Fenoprop, Mecoprop, MCPA, MCPB, Dicamba, Chloramben, TBA, Quinclorac, Quinmerac, Aminocyclopyrachlor, Benazolin, Chlorfenac/Fenac, Chlorfenprop, Naptalam, Diflufenzopyr, and other auxin mimics and/or auxin transport inhibitors known to one of ordinary skill in the art.

In additional examples, herbicides include inhibitors of fatty acid thioesterase (FAT), such as Cinmethylin, Methiozolin, and other FAT inhibitors known to one of ordinary skill in the art.

In further examples, herbicides include inhibitors of serine-threonine protein phosphatase (STPP), for example, Endothal and other STPP inhibitors known to one of ordinary skill in the art.

In other examples, herbicides include inhibitors of solanesyl diphosphate synthase (SDPS), such as Aclonifen and other SDPS inhibitors known to one of ordinary skill in the art.

In other examples, herbicides include inhibitors of lycopene cyclase, for example, Amitrole, CPTA, and other LC inhibitors known to one of ordinary skill in the art.

In additional examples, herbicides also include those with unknown or incompletely understood mechanisms of action, such as Bromobutide, Cumyluron, Difenzoquat, DSMA, Dymron/Daimuron, Etobenzanid, Flamprop, Fosamine, Methyldymron, Monalide, MSMA, Oleic acid, Oxaziclomefone, Pelargonic acid, Pyributicarb, Quinoclamine, Diphenamid, Naproanilide, Napropamide, Tebutam, Bensulide, Dalapon, Flupropanate, TCA, Mefluidide, Perfluidone, CAMA, Cacodylic acid, Copper, and other herbicides known to one of ordinary skill in the art.

In further examples, herbicides include natural product and/or organic herbicides, for example, Sorgoleone, Fischerellin A, Juglone, Ailanthone, Anthroquinone, Gliotoxin, Catechin, Thaxtomin A, Vinegar (Acetic Acid), Citric acid, Essential oils (for example, clove oil, eugenol, cinnamon oil, peppermint oil lemongrass oil, D-limonene, manuka oil, Mentha spp. extracts, etc.), herbicidal soaps (for example, ammonium soaps of fatty acids, sodium laurel sulfate, etc.), acids (pelargonic acid, caprylic acid, capric acid, etc.), corn gluten meal, phytotoxic salts (such as sodium chloride, sodium chlorate, etc.), and other natural products and/or organic herbicides known to one of ordinary skill in the art.

In specific non-limiting examples, the herbicide includes one or more of fomesafen, lactofen, 2,4-D, chlorimuron, and/or trifloxysulfuron.

### IV. Combination with Fungicides and/or Bactericides

In other aspects, the methods provided herein include application of HYT plant ameliorant to plants in combination with one or more fungicides and/or bactericides (e.g., 1, 2, 3, 4, or more fungicides and/or bactericides) either simultaneously or sequentially. This application may be further in combination with or without diluents, adjuvants, fertilizers, nutrient based additives, crop safeners, other pesticides and/or plant growth regulators, and/or other additives. Information on fungicide and bactericide classifications can be found at the Fungicide Resistance Action Committee website (www.ifrac.info/docs/). Fungicides and bactericides in these mixtures include salts, esters, pro-fungicide/pro-bactericides variations, dimers, conjugates, and formulated versions of fungicide and/or bactericide actives, such as those listed below.

In some aspects, a fungicide and/or bactericide includes agents that target nucleic acid metabolism. In some examples, the fungicides and/or bactericides target RNA polymerase, such as Benalaxyl, Benalaxyl M/Kiralaxyl), Furalaxyl, Metalaxyl, Metalaxyl M/Mefenoxam, Oxadixyl, Ofurace, and other actives that target RNA polymerase known to one of ordinary skill in the art. In other examples, the fungicides and/or bactericides target adenosine deaminase, for example, Bupirimate, Dimethirimol, Ethirimol, and other actives that target adenosine deaminase known to one of ordinary skill in the art. In further examples, the fungicides and/or bactericides target DNA/RNA synthesis, such as Hymexazole, Octhilinone, and other actives that target DNA/RNA synthesis known to one of ordinary skill in the art. In additional examples, the fungicides and/or bactericides target DNA topoisomerase type II (gyrase), such as Oxolinic Acid and other actives that target DNPA Topoisomerase Type II (gyrase) known to one of ordinary skill in the art. In still other examples, the fungicides and/or bactericides inhibit dihydroorotate dehydrogenase, for example, Ipflufenoquin and other actives that inhibit dihydroorotate dehydrogenase within de novo pyrimidine biosynthesis known to one of ordinary skill in the art.

In other aspects, a fungicide and/or bactericide includes agents that target cytoskeleton and motor proteins. In some examples, the fungicides and/or bactericides inhibit tubulin polymerization B1-B3, for example, Benomyl, Carbendazim, Fuberidazole, Thiabendazole, Thiophanate, Thiophanate-methyl, Dicthofencarb, Zoxamide, Ethaboxam, and other agents that inhibit Tubulin Polymerization B1-B3 known to one of ordinary skill in the art. In further examples, the fungicides and/or bactericides impact cell division (unknown site) or delocalization of spectrin-like proteins, for example, Pencycuron, Fluopicolide, Fluopimomide, and other actives that inhibit cytoskeleton and motor protein by impacting cell division (unknown site) or delocalization of spectrin-like proteins known to one of ordinary skill in the art. In other examples, the fungicides and/or bactericides include tubulin dynamics modulator or actin/myosin/fibrin function, such as Phenamacril, metrafenone, Pyriofenone, Pyridachlometyl, and other actives that inhibit tubulin dynamics or disrupt actin/myosin/fibrin function known to one of ordinary skill in the art.

In other aspects, a fungicide and/or bactericide includes agents that target respiration. In some examples, the fungicides and/or bactericides include inhibitors of complex I NADH oxido-reductase, for example, Diflumetorim, Tolfenpyrad, Fenazaquin, and other actives that inhibit respiration through Complex I NADH oxido-reductase known to one of ordinary skill in the art. In other examples, the fungicides and/or bactericides include inhibitors of succinate dehydrogenase, such as Benodanil, Flutolanil, Mepronil, Isofetamid, Fluopyram, Cyclobutrifluram, Fenfuram, Carboxin, Oxycarboxin, Thifluzamide, Benzovindiflupyr, Bixafen, Fluindapyr, Fluxapyroxad, Furametpyr, Inpyrfluxam, Isopyrazam, Penflufen, Penthiopyrad, Sedaxane, Isoflucypram, Pydiflumetofen, Boscalid, Pyraziflumid, and other actives that inhibit respiration through Succinate dehydrogenase known to one of ordinary skill in the art. In further examples, the fungicides and/or bactericides include inhibitors of complex III: cytochrome bc1 (ubiquinol oxidase) at Qo site (cytb), for example, Azoxystrobin, Coumoxystrobin, Enoxastrobin, Flufenoxystrobin, Picoxystrobin, Pyraoxystrobin, Mandestrobin, Pyraclostrobin, Pyrametostrobin, Triclopyricarb, Kresoxim-methyl, Trifloxystrobin, Dimoxystrobin, Fenaminstrobin, Metominostrobin, Orysastrobin, Famoxadone, Fluoxastrobin, Fenamidone, Pyribencarb, Metyltetraprole, and other actives that inhibit respiration through Complex III: Cytochrome bc1 (ubiquinol oxidase) at Qo site (cyt b gene) known to one of ordinary skill in the art. In additional examples, the fungicides and/or bactericides include inhibitors of complex III: cytochrome bc1 (ubiquinone reductase) at Qi site or the Qo site, stigmatellin binding sub-site, such as Cyazofamid, Amisulbrom, Fenpicoxamid, Florylpicoxamid, Ametoctradin, and other actives that inhibit respiration through Complex III: Cytochrome bc1 (ubiquinone reductase) at Q1 site or the Qo site, stigmatellin binding sub-site known to one of ordinary skill in the art. In further examples, the fungicides and/or bactericides include uncouplers of oxidative phosphorylation, such as Binapacryl, Meptyldinocap, Dinocap, Fluazinam, and other actives that inhibit respiration as uncouplers of oxidative phosphorylation known to one of ordinary skill in the art. In still further examples, the fungicides and/or bactericides include inhibitors of oxidative phosphorylation, ATP synthase, or ATP transport (proposed), for example, Fentin acetate, Fentin chloride, Fenton hydroxide, Silthiofam, and other actives that inhibit respiration through inhibition of oxidative phosphorylation, ATP synthase or ATP transport (proposed) known to one of ordinary skill in the art.

In additional aspects, a fungicide and/or bactericide includes agents that target amino acid and protein synthesis. In some examples, the fungicides and/or bactericides include inhibitors of ribosome initiation, elongation, or termination steps, such as Blasticidin-S, Kasugamycin, Streptomycin, Oxytetracyline, and other actives that inhibit ribosome initiation, elongation, or termination steps known to one of ordinary skill in the art. In other examples, the fungicides and/or bactericides include inhibitors of methionine biosynthesis (cgs gene), for example, Cyprodinil, Mepanipyrim, Pyrimethanil, and other actives that inhibit amino acid and protein synthesis through a proposed inhibition of methionine biosynthesis (cgs gene) known to one of ordinary skill in the art.

In other aspects, a fungicide and/or bactericide includes agents that target signal transduction. In some examples, the fungicides and/or bactericides include agents that disrupt signal transduction through MAP/histidine kinase in osmotic signal transduction (os-2, HOGg1, os-2, Daf-1), for example, Fenpiclonil, Fludioxonil, Chlozolinate, Dimethachlone, Iprodione, Procymidone, Vinclozolin, and other actives that disrupt signal transduction through Map/Histidine-Kinase in osmotic signal transduction (os-2, HOGg1 and os-2, Daf1) known to one of ordinary skill of the art.

In additional aspects, a fungicide and/or bactericide includes agents that target lipid synthesis or transport/membrane integrity function (for example, through cell peroxidation, disruption of cell permeability/integrity, ergosterol binding, disruption of lipid homeostasis/storage, and interaction with lipid fraction of the cell membrane). In some examples, the fungicides and/or bactericides include Biphenyl, Chloroneb, Dicloran, Quintozene (PCNB) Tecnazene (TCNB), Tolclofos-methyl, Etridiazole, Iodocarb, Propamocarb, Prothiocarb, Natamycin, Pimaricin, Oxathiapiprolin, Fluoxapiprolin, Polypeptide ASFBIOF01-22, and other actives that disrupt lipid synthesis or transport and membrane integrity function known to one of ordinary skill in the art.

In other aspects, a fungicide and/or bactericide includes agents that inhibit sterol biosynthesis. In some examples, the fungicides and/or bactericides inhibit C14-demethylase in sterol biosynthesis (erg11/cyp51), such as Triforine, Pyrifenox, Pyrisoxazole, Fenarimol, Nuarimol, Imazalil, Oxpoconazole, Pefurazoate, Prochloraz, Triflumizole, Azaconazole, Bitertanol, Bromuconazole, Cyproconazole, Difenoconazole, Diniconazole, Epoxiconazole, Etaconazole, Fenbuconazole, Fluquinconazole, Flusilazole, Flutriafol, Hexaconazole, Imibenconazole, Ipconazole, Mefentrifluconazole, Metconazole, Myclobutanil, Penconazole, Propiconazole, Simeconazole, Tebuconazole, Tetraconazole, Triadimefon, Triadimefon, Triadimenol, Triticonazole, Prothioconazole, and other actives that inhibit sterol biosynthesis at C14-demethylase (erg11/cyp51) known to one of ordinary skill in the art. In other examples, the fungicides and/or bactericides inhibit Δ¹⁴ reductase and Δ⁸→Δ⁷ isomerase in sterol biosynthesis (erg24, erg2), for example, Aldimorph, Dodemorph, Fenpropimorph, Tridemorph, Fenpropidin, Piperalin, Spiroxamine, and other actives that inhibit sterol biosynthesis at Δ¹⁴ reductase and Δ⁸→Δ⁷ isomerase (erg24, erg2) known to one of ordinary skill in the art. In further examples, the fungicides and/or bactericides inhibit 3-keto reductase, C4-de-methylation (erg27), such as Fenhexamid, Fenpyrazamine, and other actives that inhibit sterol biosynthesis at 3-keto reductase, C4-de-methylation (erg27) known to one of ordinary skill in the art. In other examples, the fungicides and/or bactericides inhibit squalene-epoxidase in sterol biosynthesis (erg1), such as Pyributicarb, Naftifine, Terbinafine, and other actives that inhibit sterol biosynthesis at squalene-epoxidase (erg1) known to one of ordinary skill in the art.

In other aspects, a fungicide and/or bactericide includes agents that inhibit cell wall biosynthesis. In some examples, the fungicides and/or bactericides inhibit cellulose synthase or chitin synthase, such as Polyoxin, Dimethomorph, Flumorph, Pyrimorph, Benthiavalicarb, Iprovalicarb, Valifenalate, Mandipropamid, and other actives that inhibit cell wall biosynthesis known to one of ordinary skill in the art.

In further aspects, a fungicide and/or bactericide includes agents that inhibit melanin synthesis in cell walls, for example through reductase, dehydratase, or polyketide synthase. In some examples, the fungicides and/or bactericides include Fthalide, Pyroquilon, Tricyclazole, Carpropamid, Diclocymet, Fenoxanil, Toprocarb, and other actives that inhibit melanin synthesis in cell walls known to one of ordinary skill in the art.

In other aspects, a fungicide and/or bactericide includes agents that induce host plant defense (such as salicylate-related, polysaccharide elicitors, anthraquinone elicitors, microbial elicitors, or phosphonates). In some examples, the fungicides and/or bactericides include Acibenzolar-S-methyl, Probenazole, Tiadinil, Isotianil, Laminarin, Reynoutria sachalinensis (Giant Knotweed) extract, Bacillus Mycoides isolate J, Saccharomyces cerevisiae strain LAS 177 cell walls, Fosetyl-Al, Phosphorous Acid and Salts, Dichlobentiazox, and other actives that induce host plant defenses known to one of ordinary skill in the art.

In other aspects, a fungicide and/or bactericide includes agents that have unknown or poorly defined mechanisms of action, for example, Cymoxanil, Tecloftalam, Triazoxide, Flusulfamide, Diclomezine, Cyflufenamid, Dodine, Flutianil, Fermizone, Tebufloquin, Picarbutrazox, Validamycin, Mineral Oils, Organic Oils, Inorganic Salts, Various Materials of Biological Origin, and other actives, oils, or materials of biological origin known to one of ordinary skill in the art.

In further aspects, a fungicide and/or bactericide includes agents that exhibit multi-site activity. In some examples, the fungicides and/or bactericides include Copper salts, Sulphur, Amobam, Ferbam, Mancozeb, Maneb, Metiram, Propineb, Thiram, Zinc Thiazole, Zineb, Ziram, Captan, Captafol, Folpet, Chlorothalonil, Dichlofluanid, Tolyfluanid, Guazatine, Iminoctadine, Anilazine, Dithianon, Chenomethionat/Quinomethionate, Fluoroimide, Methasulfocarb, and other actives that target multiple sites of action known to one of ordinary skill in the art.

In other aspects, a fungicide and/or bactericide includes biologicals, for example, Plant Extracts and Microbials (living microbes or extracts of metabolites). In some examples, the fungicides and/or bactericides include Lupine Plantlets (“BLAD”) cotyledon extracts, Swinglea Glutinosa extract, Tea tree (Melaleuca alternifolia) oil extract, Various Plant Oils (Eugenol, Geraniol, Thymol, etc.), Trichoderma spp. [(T. atroviride strains I-1237, LU132, SC1, SKT-1, 77B, other), (T. asperellum strains T34, kd, other), (T. harzianum strains T-22, other)], Clonastachys spp. (C. rosea strains J1446, CR-7, other), Coniothyrium spp. (C. minitans strains CON/M/91-08, other), Hansensiaspora spp. (H. uvarum strains BC18Y, other), Talaromyces spp. (T. flavus strains SAY-Y-94-01), Saccharomyces spp. (S. cerevisae strains LAS02, DDSF623, other), Bacillus spp. [(B. amyloliquefaciens strains QST713, FZB24, MBI600, D747, F727, AT-322, other), (B. subtilis strains AFS032321, Y1336, HAI-0404, other)], Erwinia spp. (peptide PHC25279, other), Gluconobacter spp. (G. cerinus strains BC18B, other), Pseudomonas spp. (P. chlororaphis strains AFS009, other), Streptomyces spp. [(S. griseovirides strains K61, other), (S. lydicus strains WYEC108, other)], and other biological plant extracts and microbes (either living microbes or extracts of metabolites from microbes) known to one of ordinary skill in the art.

In particular non-limiting examples, the fungicide is one or more of PCNB, pydiflumetofen, and/or propiconazole.

### V. Combination with Insecticides, Miticides, and/or Nematicides

In other aspects, the methods provided herein include application of HYT plant ameliorant to plants in combination with one or more insecticides, miticides, and/or nematicides (e.g., 1, 2, 3, 4, or more insecticides, miticides, and/or nematicides) either simultaneously or sequentially. This application may be further in combination with or without diluents, adjuvants, fertilizers, nutrient based additives, crop safeners, other pesticides and/or plant growth regulators, and/or other additives. Information on insecticide classifications can be found at the Insecticide Resistance Action Committee website (irac-online.org/training-centre/teaching-materials/). Insecticides, miticides, and/or nematicides in these mixtures include salts, esters, pro-insecticide/pro-miticide/pro-nematicide variations, dimers, conjugates, and formulated versions of insecticide, miticides, and/or nematicide actives, such as those listed below.

In some examples, the insecticide, miticide, and/or nematicide includes chordotonal organ or chordotonal organ TRPV channel modulators, such as Pymetrozine, Pyrifluquiazon, Afidopyropen, Flonicamid, and other actives that target chordotonal organ or chordotonal organ TRPV channel modulators known to one of ordinary skill in the art.

In other examples, the insecticide, miticide, and/or nematicide includes sodium channel modulators and/or voltage-dependent sodium channel blockers, for example, Bifenthrin, Cypermethrin, Deltamethrin, Esfenvalerate, Etofenprox, lambda-cyhalothrin, Permethrin, Tefluthrin, DDT, Methoxychlor, Indoxacarb, Metaflumizone, and other actives that act as sodium channel modulators and/or voltage-dependent sodium channel blockers known to one of ordinary skill in the art.

In further examples, the insecticide, miticide, and/or nematicide includes agents that modulate nicotinic acetylcholine receptors (nACHR), such as competitive modulators, allosteric modulators (site I or site II), and/or channel blockers. In some examples, the insecticide, miticide, and/or nematicide includes Acetamiprid, Dinotefuran, Chlothianidin, Imidacloprid, Nitenpyram, Thiacloprid, Thiamethoxam, Nicotine, Sulfoxaflor, Flupyradifurone, Triflumezopyrim, Spinetoram, Spinosad, GS-omega/kappa HXTX-Hv1a peptide, Bensultap, Cartap hydrochloride, Thiosultap-sodium, and other actives that modulate nicotinic acetylcholine receptors (nACHR) known to one of ordinary skill in the art.

In other examples, the insecticide, miticide, and/or nematicide includes GABA-gated chloride channel antagonists and/or allosteric modulators, such as Chlordane, Endosulfan, Ethiprole, Fipronil, Broflanilide, Fluxametamide, and other actives that act as GABA-gated chloride channel antagonists and/or allosteric modulators known to one of ordinary skill in the art.

In additional examples, the insecticide, miticide, and/or nematicide includes allosteric modulators of glutamate-gated chloride channels (GluCI), for example, Abamectin, Emamectin, Lepimectin, Millbemectin, and other actives that act as allosteric modulators of Glutamate-gated chloride channels (GluCI) known to one of ordinary skill in the art.

In other examples, the insecticide, miticide, and/or nematicide includes ryanodine receptor (RyR) modulators, such as Chlorantraniliprole, Cyantraniliprole, Cyclaniliprole, Flubendiamide, Tetraniliprole, and other RyR modulators known to one of ordinary skill in the art.

In further examples, the insecticide, miticide, and/or nematicide includes acetylcholinesterase (AChE) inhibitors, for example, Aldicarb, Aminocarb, Bendiocarb, Butocarboxim, Methiocarb, Oxamyl, Carbaryl, Dimetilan, Ethiofencarb, Fenobucarb, Fenoxycarb, Formetanate, Formparanate, Metolcarb, Mexacarbate, Methomyl, Thiodicarb, Carbofuran, Carbosulfan, M-Cumenyl Methylcarbamate, Pirimicarb, Promecarb, Propoxur, Thiofanox, Acephate, Fenitrothion, Methamidophos, Azinphos, BAY-29952, Chlorethoxyfos, Chlorpyrifos, Crufomate, Cyanophos, Diazinon, Dicrotophos, Dichlorvos, Ethoprop, Ethoprophos, Fenamiphos, Fenthion, Fensulfothion, Fonofos, Formothion, Isoxathion, Malathion, Methamidophos, Metrifonate/Trichlorfon, Mevinphos, Naled, Omethoate, Oxydemeton, Phorate, Phosalone, Phosfolan, Phosmet, Phosphamidon, Phoxim, Profenofos, Propetamphos, Prothoate, Quinalphos, Dimethoate, Dioxathion, Sulfotep (TEDP/Dithione/Dithiophos), Tebupirimfos, Temefos, Terbufos, Triazophos, Trichloronate, and other AChE inhibitors known to one of ordinary skill in the art.

In additional examples, the insecticide, miticide, and/or nematicide includes octopamine receptor agonists, such as amitraz and other octopamine receptor inhibitors known to one of ordinary skill in the art.

In other examples, the insecticide, miticide, and/or nematicide includes juvenile hormone mimics, for example, Hydropene, Methoprene, Kinoprene, Fenoxycarb, Pyriproxyfen, and other actives that act as juvenile hormone mimics known to one of ordinary skill in the art.

In further examples, the insecticide, miticide, and/or nematicide includes ecdysone receptor agonist, such as Chromafenozide, Halofenozide, Methoxyfenozide, Tebufenozide, and other ecdysone receptor agonists known to one of ordinary skill in the art.

In other examples, the insecticide, miticide, and/or nematicide includes chitin synthesis inhibitors (such as those affecting CHS1, mite growth inhibitors affecting CHS1, and chitin biosynthesis inhibitors), for example, Clofentezine, Diflovidazin, Hexythiazox, Etoxazole, Diflubenzuron, Flufenoxuron, Lefenuron, Novaluron, Teflubenzuron, Buprofezin, and other actives that inhibit chitin synthesis known to one of ordinary skill in the art.

In additional examples, the insecticide, miticide, and/or nematicide includes inhibitors of acetyl CoA carboxylase, such as Spirodiclofen, Spiromesifen, Spirotetramat, and other actives that inhibit acetyl CoA carboxylase known to one of ordinary skill in the art.

In further examples, the insecticide, miticide, and/or nematicide includes inhibitors of mitochondrial cellular respiration complexes I-V, for example, Fenazaquin, Fenpyroximate, Pyridaben, Pyrimidifen, Tebufenpyrad, Tolfenpyrad, Rotenone, Cyenopyrafen, Cyflumetofen, Pyflubumide, Hydramethylnon, Acequinocyl, Fluacrypyrim, Bifenazate, Aluminum Phosphide, Calcium Phosphide, Zinc Phosphide, Phosphine, Cyanide salts, Diafenthiuron, Azocyclotin, Cyhexatin, Fenbutatin oxide, Propargite, Tetradifon, and other actives that inhibit mitochondrial cellular respiration complexes I-V known to one of ordinary skill in the art.

In other examples, the insecticide, miticide, and/or nematicide includes uncouplers of oxidative phosphorylation such as Chlorfenapyr, DNOC, Sulfluramid, and other actives that are uncouplers of oxidative phosphorylation known to one of ordinary skill in the art.

In additional examples, the insecticide, miticide, and/or nematicide includes microbial disruptors of insect midgut, for example, Bacillus thuringiensis (Bt), B.t. israelensis, B.t. aitzawai, B.t. kurstaki, B.t. tenebrionis, Bacillus sphaericus, and Bt crop proteins Cry1Ab, Cry1Ac, Cry1Fa, Cry1A.105, Cry2Ab, Vip3A, mCry3A, Cry3Ab, Cry3Bb, Cry34Ab1/Cry25Ab1, and other microbial disruptors of insect midgut known to one of ordinary skill in the art. In other examples, the insecticide, miticide, and/or nematicide includes baculoviruses acting on insect midgut such as Cydia pomonella GV, Thaumatotibia leucotreta GV, Anticarsia gemmatalis MNPV, Helicoverpa armigera NPV, and other baculoviruses acting on insect midgut known to one of ordinary skill in the art.

In other examples, the insecticide, miticide, and/or nematicide includes non-specific multi-site inhibitors such as Methyl Bromide, Chloropicrin, Cryolite, Sulfuryl Fluoride, Borax, Tartar Emetic, Dazomet, Metam, and other non-specific multi-site inhibitors known to one of ordinary skill in the art.

In further examples, the insecticide, miticide, and/or nematicide includes agents with unknown or poorly understood mechanisms of action (including bacterial, fungal, synthetics, oils, extracts, non-specific mechanical distruptors), for example, Azadirachtin, Benzoximate, Bromopropylate, Chinomethionat, Dicofol, Fluensulfone, Mancozeb, Pyridalyl, Sulfurs, CaSX (lime sulfur), Burkholderia spp., Wolbachia pipientis (Zap), Chenopodium ambrosiodides extra, Fatty acid monoesters (plus glycerol or propanediol), Neem Oil, Beauveria bassiana strains, Metarhizium anisopliae strain F52, Purpureocillium lilacinus strain 251, Paecilomyces fumosoroseus/Isaria fumosorosea Apopka strain 97, Diatomaceous earth, extracts of Clitoria ternatea and others agents with unknown or poorly understood mechanisms of action known to one of ordinary skill in the art.

### VI. Combination with Plant Growth Regulators

In other aspects, the methods provided herein include application of HYT plant ameliorant to plants in combination with one or more plant growth regulators (e.g., 1, 2, 3, 4, or more plant growth regulators) either simultaneously or sequentially. This application may be further in combination with or without diluents, adjuvants, fertilizers, nutrient based additives, crop safeners, other pesticides and/or plant growth regulators, and/or other additives. Plant growth regulators in these mixtures include salts, esters, pro-regulator variations, dimers, conjugates, and formulated versions of plant growth regulators, such as those listed below.

In some examples, the plant growth regulators include Abscisic acid (and synthetic mimics of abscisic acid), 6-Benzyl Adenine, Alcohols, Anycmidol, Auxins (and synthetic mimics of auxins), Brassinosteroids (and synthetic mimics of brassinosteroids), Brassinolide, Benzyladenine, Butralin, Butyl Phosphorotrithioate, Chlormequat, Cytokinins (and synthetic mimics of cytokinins), Cyclanilide, Daminozide, n-Decanol, Dikegulac, Dimethipin, Ethephon, Ethylene, Flurprimidol, Gibberellins (and synthetic mimics of gibberellins), Indolebutyric Acid, Indoleacetic Acid, Jasmonates/Jasmonic Acid (and synthetic mimics of jasmonates/jasmonic acid) Maleic Hydrazide, Mefluidide, Mepiquat, Napthalene Acetic Acid, 1-Naphthaleneacetamide, Nitric Oxide (and synthetic mimics of nitric oxide), Paclobutrazol, Polyamines, Prohexadione, Salicylic Acid, Thidiazuron, TIBA, Triacontanol, Tribufos, Trinexapac, Uniconazole, and other plant growth regulators known to one of ordinary skill in the art.

In particular non-limiting examples, the plant growth regulator includes one or more of trinexapac, paclobutrazol, prohexadione, and/or flurprimidol.

### VII. Additional Aspects

Aspect 1. A method of reducing plant injury and/or increasing yield, comprising contacting a plant, plant part, soil, or soilless medium with:

an HYT plant ameliorant composition; and

one or more pesticide and/or plant growth regulator,

wherein the contacting with the HYT plant ameliorant and the one or more pesticide and/or plant growth regulator is simultaneous or sequential, thereby reducing the plant injury and/or increasing the yield.

Aspect 2. The method of aspect 1, wherein the HYT plant ameliorant composition comprises one or more of chitosan, glucosamine, amino acids, trace elements, proteins, and polysaccharides.

Aspect 3. The method of aspect 2, wherein the HYT plant ameliorant composition comprises about 1-5% (w/v) total amino acids, about 3-10% (w/v) protein, about 0.5-2% (w/v) nitrogen, less than about 0.2% (w/v) phosphorus, about 0.5-1% (w/v) potassium, about 4-8% (w/v) carbon, about 0.2-1% (w/v) calcium, less than about 0.2% (w/v) magnesium, less than about 0.2% (w/v) sodium, and/or about 0.1-0.4% (w/v) sulfur.

Aspect 4. The method of aspect 2 or aspect 3 where the HYT plant ameliorant composition comprises about 0.001-0.0% (w/v) glucosamine.

Aspect 5. The method of any one of aspects 1 to 4, wherein the plant, plant part, soil, or soilless medium is contacted with the HYT plant ameliorant composition at a rate of about 0.25 to about 20 liters/hectare.

Aspect 6. The method of any one of aspects 1 to 5, wherein the one or more pesticide comprises one or more herbicide, one or more insecticide, one or more fungicide, one or more bactericide, one or more miticide, or one or more nematicide.

Aspect 7. The method of any one of aspects 1 to 5, wherein the one or more plant growth regulator comprises abscisic acid, 6-Benzyl adenine, an alcohol, anycmidol, an auxin, a brassinosteroid, brassinolide, benzyladenine, butralin, butyl phosphorotrithioate, chlormequat, a cytokinins, cyclanilide, daminozide, n-decanol, dikegulac, dimethipin, ethephon, ethylene, flurprimidol, a gibberellin, indolebutyric acid, indoleacetic acid, a jasmonate, jasmonic acid, maleic hydrazide, mefluidide, mepiquat, napthalene acetic acid, 1-naphthaleneacetamide, nitric oxide, paclobutrazol, polyamines, prohexadione, salicylic acid, thidiazuron, TIBA, triacontanol, tribufos, trinexapac, or uniconazole.

Aspect 8. The method of any one of aspects 1 to 7, further comprising contacting the plant, plant part, soil, or soilless medium with one or more additional tank mix additives or formulation components.

Aspect 9. The method of aspect 8, wherein the one or more additional tank mix additives or formulation components comprise one or more diluents, formulation additives, adjuvants, fertilizers, nutrient based additives, drift retardants, defoaming agents, crop safeners, dyes, and/or antidotes.

Aspect 10. The method of any one of aspects 1 to 9, wherein the plant, plant part, soil, or soilless medium are contacted with the HYT plant ameliorant and the one or more pesticide and/or plant growth regulator simultaneously.

Aspect 11. The method of any one of aspects 1 to 9, wherein the plant, plant part, soil, or soilless medium are contacted with the HYT plant ameliorant and the one or more pesticide and/or plant growth regulator sequentially.

Aspect 12. The method of aspect 11, wherein the plant, plant part, soil, or soilless medium is contacted with the HYT plant ameliorant about 1 hour to 12 months prior to contacting the plant, plant part, soil, or soilless medium with the one or more pesticide and/or plant growth regulator.

Aspect 13. The method of any one of aspects 1 to 12, wherein the plant, plant part, soil, soilless media, water, or other media or environments where plants grow is contacted with the HYT plant ameliorant and/or the one or more pesticide or plant growth regulator one or more times.

Aspect 14. The method of any one of aspects 1 to 13, wherein plant part comprises one or more of foliage, roots, seeds, grafts, and fruit bodies.

Aspect 15. The method of any one of aspects 1 to 14, wherein the plant is selected from the group consisting of alfalfa, corn (maize), sweet corn, popcorn, hemp, sorghum, millet, milo, cotton, soybean, edamame, sugarbeet, sugarcane, safflower, sunflower, canola, rape, peanut, rice, barley, oat, triticale, rye, wheat, agave, potato, flax, tobacco, mushroom, fruit trees like apple, apricot, avocado, banana, blackberry, raspberry, loganberry, blackcurrant, blueberry, cherry, cranberry, fig, orange, grapefruit, lemon, lime, mandarin, clementine, tangerine, olive, grape, guava, kiwi, mango, nectarine, papaya, peach, pear, persimmon, pineapple, plum, pomegranate, quince, strawberry, tomato, eggplant, pepper, melon, cucumber, watermelon, pumpkin, squash, zucchini, cantaloupe, honeydew, nuts like almond, beech, butternut, brazil nut, candlenut, cashew, chestnuts, filbert, hickory, kola nut, pecan, macadamia, maya nut, paradise nut, pili nut, pistachio, walnut, edible legumes and vegetables, turfgrass, forage grass, forage legumes, ornamental plants, hardwood trees, shrubs, vines, forbs, wild flowers, herbs, and plantation crops.

Aspect 16. The method of any one of claims 1 to 15, wherein the plant is a genetically modified plant.

Aspect 17. The method of any one of aspects 1 to 15, wherein the plant is not a genetically modified plant.

Aspect 18. The method of any one of aspects 1 to 17, further comprising assessing crop injury by measuring one or more of stunting, thinning, lodging, defoliation, bleaching, chlorosis, necrosis (burn), and root malformation.

Aspect 19. The method of any one of aspects 1 to 17, further comprising assessing crop injury by measuring one or more of plant biomass accumulation, plant height, measures of plant nutrients, chlorophyll fluorescence, measurements of light reflectance patterns of plant surfaces, transpiration, respiration, photosynthesis, and yield.

Aspect 20. The method of any one of aspects 1 to 19, wherein an improvement in one or more of pest control, desirable plant growth and appearance, and levels of crop yield results from contacting the plant, plant part, soil, or soilless medium with the HYT plant ameliorant and the one or more pesticide and/or plant growth regulator.

### EXAMPLES

The following examples are provided to illustrate particular features of certain aspects of the disclosure, but the scope of the claims should not be limited to those features exemplified.

### Example 1

Effect of HYT B in Combination with Fomesafen in Soybean

A field study was conducted in 2021 in Mantee, MS to understand how commercial “HYT plant ameliorant” B Sure® would perform in mixtures with the herbicide fomesafen in soybean. The study was arranged in a randomized complete block design with 6 replicates in conventionally tilled soybeans (Glycine max).

Herbicides were applied in a water carrier of 20 gallons per acre and treatments were applied at first flower (V5/R1). All fomesafen treatments contained an adjuvant system of 1% v/v crop oil concentrate and 2.5% v/v urea ammonium nitrate as is consistent with product label instructions. Treatments included in the trial were the following: 1) B Sure® 16 fl oz/acre; 2) B Sure® 32 fl oz/acre; 3) fomesafen 350 g ai/ha; 5) B Sure® 16 fl oz/acre+fomesafen 350 g ai/ha; 6) B Sure® 32 fl oz/acre+fomesafen 350 g ai/ha; 7) Untreated check. Visual injury was rated 2 days after application on a percent scale from 0 to 100 where 0 equals no visual response and 100 equals complete plant death.

In general, injury was between 0 and 7% with all treatments (Table 1). No injury was observed in the untreated check. Fomesafen injured the soybean 7% by 7 days after treatment, but surprisingly the addition of the B Sure® to the fomesafen treatments reduced injury to between 3 and 4%. In addition, the fomesafen treatment only increased soybean yield 4.6% while the B Sure® alone increased yields 5 to 6.3%. Surprisingly, the tank mixture of the B Sure® and fomesafen increased soybean yield between 5.9 to 7.8% more than either component applied separately at their corresponding application rates.

TABLE 1
B Sure ® + fomesafen combination treatment

| | Application | % | Soybean Yield |
|---|---|---|---|
| Treatment | rate | Injury | (% increase over untreated check) |
| Untreated check | | 0 | 0 |
| B Sure ® | 16 fl oz/A | 0 | 5.0 |
| B Sure ® | 32 fl oz/A | 0 | 6.3 |
| Fomesafen | 350 g ai/ha | 7 | 4.6 |
| Fomesafen + | 350 g ai/ha+ | 4 | 5.9 |
| B Sure ® | 16 fl oz/A | | |
| Fomesafen + | 350 g ai/ha+ | 3 | 7.8 |
| B Sure ® | 32 fl oz/A | | |

### Example 2

Effect of HYT B in Combination with Pentachloronitrobenzene in Creeping Bentgrass

A field study was conducted in southeastern Pennsylvania during July 2022 to determine the influence of the “HYT plant ameliorant” B Sure® on creeping bentgrass (Agrostis stolonifera) when applied in combinations with the fungicide pentachloronitrobenzene (PCNB). PCNB was applied at 227 g ai/per 1,000 square feet. A second treatment mixed PCNB at 227 g ai/1,000 square feet plus the “HYT plant ameliorant” B Sure® at 6 fl oz/1,000 square feet. Treatments were applied on July 14th using an application volume of 2 gallons per 1,000 square feet. Creeping bentgrass injury ratings were made five times corresponding to 3, 7, 10, 14 and 28 days after application (DAA). Visual injury was evaluated on a percent scale from 0 to 100 where 0 equals no visual response and 100 equals complete plant death. Results with the PCNB applied alone (Table 2) resulted in early creeping bentgrass ratings of 20% that progressed toward 100% injury by the end of the trial evaluations. Surprisingly, the mixture of B Sure® at 6 fl oz/1,000 square feet with PCNB at 227 g ai/1,000 sq ft resulted in 20% injury that reached a peak of 55% injury and eventually recovered to 27% injury by the end of the trial.

TABLE 2
B Sure ® + PCNB combination treatment

| | | % | % | % | % | % |
|---|---|---|---|---|---|---|
| | Application | Injury | Injury | Injury | Injury | Injury |
| Treatment | rate | 3 DAA | 7 DAA | 10 DAA | 14 DAA | 28 DAA |
| PCNB | 227 g ai/ | 20 | 100 | 100 | 100 | 100 |
| | 1,000 sq ft | | | | | |
| PCNB + | 227 g ai/ | 20 | 55 | 55 | 55 | 27 |
| B Sure ® | 1,000 sq ft + | | | | | |
| | 6 fl oz/ | | | | | |
| | 1,000 sq ft | | | | | |

### Example 3

Effect of HYT B in Combination with Herbicides in GMO Soybeans

A study was conducted in Ames, IA in the summer of 2022 to determine how a commercial “HYT plant ameliorant” B Sure® would perform in mixtures with the herbicides lactofen, 2,4-D choline salt, and chlorimuron in genetically modified (GMO) soybeans engineered to resist 2,4-D. Herbicides were applied in a water carrier of 15 gallons per acre and treatments were applied to soybeans between the V3 and R1 stage of growth. Treatments included 1) B Sure® 1 pt/A; 2) Lactofen 218 g ai/ha; 3) Lactofen 218 g ai/ha+B Sure® 1 pt/A; 4) 2,4-D choline 1064 g ai/ha; 5) 2,4-D choline 1064 g ai/ha+B Sure® 1 pt/A; 6) chlorimuron 13 g ai/ha; 7) chlorimuron 13 g ai/ha+B Sure® 1 pt/A. Adjuvants applied varied by treatment and were consistent with product label recommendations. A preemergence herbicide was applied to all treatments in order to reduce competition from weed species that would increase variability in the study. A canopy rating was made which evaluated the % ground cover differences of the soybeans associated with the various treatments. In these measurements, the larger ground cover number represents a greater amount of soybean leaf tissue which represents greater crop vigor and overall soybean health.

The addition of commercial “HYT plant ameliorant” B Sure® to the three herbicides lactofen, 2,4-D choline, and chlorimuron surprisingly increased soybean canopy by 7.4 to 12.9% when compared to the herbicides applied alone (Table 3).

TABLE 3
B Sure ® + herbicide combination treatment

| | | Canopy | % Increase in soybean |
|---|---|---|---|
| | Application | rating relative to | canopy measure with B |
| Treatment | rate | % ground cover | Sure ® added |
| Lactofen | 218 g ai/ha | 2.99 | 7.4% |
| Lactofen + | 218 g ai/ha + | 3.23 | |
| B Sure ® | 1 pt/A | | |
| 2,4-D Choline | 1064 g ai/ha | 6.18 | 12.9% |
| 2,4-D Choline + | 1064 g ai/ha + | 7.10 | |
| B Sure ® | 1 pt/A | | |
| Chlorimuron | 13 g ai/ha | 6.25 | 10.9% |
| Chlorimuron + | 13 g ai/ha + | 7.02 | |
| B Sure ® | 1 pt/A | | |

### Example 4

Effect of HYT B in Combination with Herbicides in Cotton

Six field studies were conducted in 2023 in in the states of North Carolina, Georgia, South Carolina, Mississippi, Arkansas, and Tennessee to evaluate how the “HYT plant ameliorant” B Sure® would perform in mixtures with the herbicide trifloxysulfuron in cotton (Gossypium hirsutum). The studies were arranged in a randomized complete block design with 4 replicates in conventionally tilled cotton. Evaluations were combined over locations and plots were maintained weed free over the duration of the trial.

Herbicides were applied in a water carrier to cotton at three separate stages of growth: 1) cotyledon-2 leaf; 2) 3-4 leaf; and 3) 5 leaf or greater. All trifloxysulfuron treatments contained a nonionic surfactant at 0.25% v/v as is consistent with product label instructions. Treatments included in the trial were the following: 1) trifloxysulfuron 8 g ai/ha-cotyledon-2 leaf cotton; 2) trifloxysulfuron 8 g ai/ha+B Sure® 1,170 mls/ha-cotyledon-2 leaf cotton; 3) trifloxysulfuron 8 g ai/ha+B Sure® 2 pint/acre-cotyledon-2 leaf cotton; 4) trifloxysulfuron 8 g ai/ha-3-4 leaf cotton, 5) trifloxysulfuron 8 g ai/ha+B Sure® 1,170 mls/ha-3-4 leaf cotton; 6) trifloxysulfuron 8 g ai/ha+B Sure® 2,340 mls/ha-3-4 leaf cotton; 7) trifloxysulfuron 8 g ai/ha-5 leaf or greater cotton, 8) trifloxysulfuron 8 g ai/ha+B Sure® 1,170 mls/ha-5 leaf or greater cotton; 9) trifloxysulfuron 8 g ai/ha+B Sure® 2, 340 mls/ha-5 leaf or greater cotton; 10) Check. Visual injury was rated approximately 2 to 3 weeks after application on a percent scale from 0 to 100 where 0 equals no visual response and 100 equals complete plant death.

In general, injury was between 0 and 18% with all treatments (Table 4). No injury was observed in the untreated check. Trifloxysulfuron alone injured cotton 15 to 18% when applied to cotton between the cotyledon and 4-leaf cotton stages of growth. The addition of B Sure® at 2,340 mls/ha reduced cotton injury from trifloxysulfuron when applied between cotyledon and the 4-leaf cotton stage to between 8 to 12%. At the 5-leaf stage of cotton, B Sure® at 2,340 mls/ha plus trifloxysulfuron caused no visual injury by 2 to 3 weeks after treatments when compared to trifloxysulfuron alone which caused 5% injury.

TABLE 4
B Sure ® + herbicide combination treatment in cotton

| Treatment | Application timing | Application rate | % Injury |
|---|---|---|---|
| Check | | | 0 |
| Trifloxysulfuron | Cotyledon-2 leaf | 8 g ai/ha | 18 |
| Trifloxysulfuron + | Cotyledon-2 leaf | 8 g ai/ha + 1,170 mls/ha | 16 |
| B Sure ® | | | |
| Trifloxysulfuron + | Cotyledon-2 leaf | 8 g ai/ha + 2,340 mls/ha | 12 |
| B Sure ® | | | |
| Trifloxysulfuron | 3 − 4 leaf | 8 g ai/ha | 15 |
| Trifloxysulfuron + | 3 − 4 leaf | 8 g ai/ha + 1,170 mls/ha | 10 |
| B Sure ® | | | |
| Trifloxysulfuron + | 3 − 4 leaf | 8 g ai/ha + 2,340 mls/ha | 8 |
| B Sure ® | | | |
| Trifloxysulfuron | 5 + leaf | 8 g ai/ha | 5 |
| Trifloxysulfuron + | 5 + leaf | 8 g ai/ha + 1,170 mls/ha | 2 |
| B Sure ® | | | |
| Trifloxysulfuron + | 5 + leaf | 8 g ai/ha + 2,340 mls/ha | 0 |
| B Sure ® | | | |

### Example 5

Effect of HYT B in Combination with Herbicides in GMO Soybeans

Four field studies were conducted in 2023 in the states of Ohio, Nebraska, Indiana, and Illinois to determine the influence of the “HYT plant ameliorant” B Sure® at 1,170 mls/ha on soybean (Glycine max) yield when applied in combinations with the herbicides lactofen at 210 g ai/ha and 2,4-D (as its choline salt) at 2,527 g ai/ha on genetically modified (GM) soybeans (Enlist E3® soybeans) created to tolerate applications of 2,4-D, glufosinate, and glyphosate. Treatments were applied using a water carrier with crop oil concentrate added to all treatments at 1% v/v and ammonium sulfate at 2.24 kg/ha added to herbicide containing treatments. Yields were adjusted to constant moisture and recorded in bushels/acre. The studies were arranged in a randomized complete block design with 6 replicates in conventionally tilled soybean. All plots were maintained weed free.

Soybean yields ranged between 61.5 to 66.3 bushels/acre (Table 5). The B Sure® alone increased soybean yield by 3.6 bushels/acre over the check, but the lactofen herbicide reduced yield over the untreated check by 0.7 bushels/acre. The addition of B Sure® to the lactofen treatment added an extra 3.2 bushels/acre over lactofen applied alone for a 2.5 bushels/acre increase over the check in these GM soybeans. Similarly, 2,4-D increased soybean yields by 3.1 bushels/acre and the addition of B Sure® added an additional bushel of soybeans over the 2,4-D applied alone. Surprisingly, B Sure® increased the yield of two different herbicides with two distinct sites of action in a GM crop whereby one herbicide (2,4-D) required the GM trait for use on the soybean variety used in this trial and the other herbicide (lactofen) has a natural level of tolerance whereby it can be used in many soybean varieties including the one evaluated in this trial.

TABLE 5
B Sure ® + herbicide combination treatment in soybeans

| | | Yield |
|---|---|---|
| Treatments | Application rate | (bushels/acre) |
| Check | | 62.2 |
| B Sure ® | 1,170 mls/ha | 65.8 |
| Lactofen | 210 g ai/ha | 61.5 |
| Lactofen + B Sure ® | 210 g ai/ha + 1,170 mls/ha | 64.7 |
| 2,4-D (choline salt) | 2,527 g ai/ha | 65.3 |
| 2,4-D (choline salt) + B Sure ® | 2,527 g ai/ha + 1,170 mls/ha | 66.3 |

### Example 6

Effect of HYT B in Combination with Fungicides in Wheat

Six field studies were conducted in 2023 in the states of Kentucky, Pennsylvania, Mississippi, Missouri, North Dakota, and Nebraska to determine the influence of the “HYT plant ameliorant” B Sure® at 1,170 mls/ha on wheat (Triticum aestivum) yield when applied in combinations with a fungicide premix containing 150 g ai/ha pydiflumetofen plus 126 g ai/ha propiconazole. Treatments were applied to wheat at Feekes stage 10.5 using a water carrier with nonionic surfactant at 0.25% v/v. The studies were arranged in a randomized complete block design with 6 replicates in conventionally tilled wheat. Yields were adjusted to constant moisture and recorded in bushels/acre. All plots were maintained weed free.

Wheat yields ranged between 63.6 to 70.3 bushels/acre (Table 6). The B Sure® alone increased soybean yield by 3.6 bushels/acre over the check and the fungicide premix of pydiflumetofen plus propiconazole increased 4.4 bushels/acre over the check, but surprisingly the combination of B Sure® plus the fungicide premix increased wheat yields by 6.7 bushels/acre over the check. Interestingly, B Sure® and the fungicide premix alone increased wheat protein yield each by 0.04% when compared to check, but when both were combined in a mixture together, they increased wheat protein by 0.32%.

TABLE 6
B Sure ® + fungicide combination treatment in wheat

| | | Yield | Protein |
|---|---|---|---|
| Treatments | Application rate | (bushels/acre) | (%) |
| Check | | 63.6 | 11.94 |
| B Sure ® | 1,170 mls/ha | 67.2 | 11.98 |
| Pydiflumetofen + | 150 g ai/ha + 126 g ai/ha | 68 | 11.98 |
| Propiconazole | | | |
| Pydiflumetofen + | 150 g ai/ha + 126 g ai/ha + | 70.3 | 12.26 |
| Propiconazole + | 1,170 mls/ha | | |
| B Sure ® | | | |

### Example 7

Effect of HYT B in Combination with Plant Growth Regulators in Bentgrass Turf

A field trial was initiated on May 19, 2023, in Spring City, PA to determine how the “HYT plant ameliorant” B Sure® at 19,091 mls/ha improved phytotoxicity created by various plant growth regulators and their combinations on creeping bentgrass (Agrostis palustris) turf. Each plant growth regulator (PGR) combination was applied in 2 gallons of water per 1,000 square feet and applications were made 6 times with application intervals every two weeks. Visual injury was rated 8 times between June 8th and August 11^{th} on a percent scale from 0 to 100 where 0 equals no visual response and 100 equals complete plant death. Visual ratings were combined, and results of those assessments are below (Table 7). In the absence of B Sure® each PGR alone or in combination together caused 10 to 22% phytotoxicity. Surprisingly, B Sure® reduced phytotoxicity associated with all PGR applications. Phytotoxicity with B Sure® plus PGR mixtures was between 4 to 11%.

TABLE 7
B Sure ® + plant growth regulators in
combination treatment in bentgrass turf

| | | % |
|---|---|---|
| Treatments | Application rate | Phytotoxicity |
| Check | **** | |
| Trinexapac-ethyl | 514 g ai/ha | 10 |
| Trinexapac-ethyl + B Sure ® | 514 g ai/ha + 19,091 ml/ha | 5 |
| Paclobutrazol | 280 g ai/ha | 10 |
| Paclobutrazol + B Sure ® | 280 g ai/ha + 19,091 ml/ha | 6 |
| Prohexadione-calcium | 154 g ai/ha | 12 |
| Prohexadione-calcium + | 154 g ai/ha + 19,091 ml/ha | 4 |
| B Sure ® | | |
| Flurprimidol | 15 g ai/ha | 16 |
| Flurprimidol + B Sure ® | 15 g ai/ha + 19,091 ml/ha | 11 |
| Prohexadione-calcium + | 154 g ai/ha + 514 g ai/ha | 11 |
| Trinexapac-ethyl | | |
| Prohexadione-calcium + | 154 g ai/ha + 514 g ai/ha + | 8 |
| Trinexapac-ethyl + B Sure ® | 19,091 ml/ha | |
| Prohexadione-calcium + | 154 g ai/ha + 280 g ai/ha | 22 |
| Paclobutrazol | | |
| Prohexadione-calcium + | 154 g ai/ha + 280 g ai/ha + | 10 |
| Paclobutrazol + B Sure ® | 19,091 ml/ha | |

It will be apparent that the precise details of the methods or compositions described may be varied or modified without departing from the spirit of the described aspects of the disclosure. We claim all such modifications and variations that fall within the scope and spirit of the claims below.

We claim:

1. A method of reducing plant injury and/or increasing yield, comprising contacting a plant, plant part, soil, or soilless medium with:
an HYT plant ameliorant composition; and
one or more pesticide and/or plant growth regulator,
wherein the contacting with the HYT plant ameliorant and the one or more pesticide and/or plant growth regulator is simultaneous or sequential,
thereby reducing the plant injury and/or increasing the yield.

2. The method of claim 1, wherein the HYT plant ameliorant composition comprises one or more of chitosan, glucosamine, amino acids, trace elements, proteins, and polysaccharides.

3. The method of claim 2, wherein the HYT plant ameliorant composition comprises about 1-5% (w/v) total amino acids, about 3-10% (w/v) protein, about 0.5-2% (w/v) nitrogen, less than about 0.2% (w/v) phosphorus, about 0.5-1% (w/v) potassium, about 4-8% (w/v) carbon, about 0.2-1% (w/v) calcium, less than about 0.2% (w/v) magnesium, less than about 0.2% (w/v) sodium, and/or about 0.1-0.4% (w/v) sulfur.

4. The method of claim 2, wherein the HYT plant ameliorant composition comprises about 0.001-0.0% (w/v) glucosamine.

5. The method of claim 1, wherein the plant, plant part, soil, or soilless medium is contacted with the HYT plant ameliorant composition at a rate of about 0.25 to about 20 liters/hectare.

6. The method of claim 1, wherein the one or more pesticide comprises one or more herbicide, one or more insecticide, one or more fungicide, one or more bactericide, one or more miticide, or one or more nematicide.

7. The method of claim 1, wherein the one or more plant growth regulator comprises abscisic acid, 6-Benzyl adenine, an alcohol, anycmidol, an auxin, a brassinosteroid, brassinolide, benzyladenine, butralin, butyl phosphorotrithioate, chlormequat, a cytokinins, cyclanilide, daminozide, n-decanol, dikegulac, dimethipin, ethephon, ethylene, flurprimidol, a gibberellin, indolebutyric acid, indoleacetic acid, a jasmonate, jasmonic acid, maleic hydrazide, mefluidide, mepiquat, napthalene acetic acid, 1-naphthaleneacetamide, nitric oxide, paclobutrazol, polyamines, prohexadione, salicylic acid, thidiazuron, TIBA, triacontanol, tribufos, trinexapac, or uniconazole.

8. The method of claim 1, further comprising contacting the plant, plant part, soil, or soilless medium with one or more additional tank mix additives or formulation components.

9. The method of claim 8, wherein the one or more additional tank mix additives or formulation components comprise one or more diluents, formulation additives, adjuvants, fertilizers, nutrient based additives, drift retardants, defoaming agents, crop safeners, dyes, and/or antidotes.

10. The method of claim 1, wherein the plant, plant part, soil, or soilless medium are contacted with the HYT plant ameliorant and the one or more pesticide and/or plant growth regulator simultaneously.

11. The method of claim 1, wherein the plant, plant part, soil, or soilless medium are contacted with the HYT plant ameliorant and the one or more pesticide and/or plant growth regulator sequentially.

12. The method of claim 11, wherein the plant, plant part, soil, or soilless medium is contacted with the HYT plant ameliorant about 1 hour to 12 months prior to contacting the plant, plant part, soil, or soilless medium with the one or more pesticide and/or plant growth regulator.

13. The method of claim 1, wherein the plant, plant part, soil, soilless media, water, or other media or environments where plants grow is contacted with the HYT plant ameliorant and/or the one or more pesticide and/or plant growth regulator one or more times.

14. The method of claim 1, wherein plant part comprises one or more of foliage, roots, seeds, grafts, and fruit bodies.

15. The method of claim 1, wherein the plant is selected from the group consisting of alfalfa, corn (maize), sweet corn, popcorn, hemp, sorghum, millet, milo, cotton, soybean, edamame, sugarbeet, sugarcane, safflower, sunflower, canola, rape, peanut, rice, barley, oat, triticale, rye, wheat, agave, potato, flax, tobacco, mushroom, fruit trees like apple, apricot, avocado, banana, blackberry, raspberry, loganberry, blackcurrant, blueberry, cherry, cranberry, fig, orange, grapefruit, lemon, lime, mandarin, clementine, tangerine, olive, grape, guava, kiwi, mango, nectarine, papaya, peach, pear, persimmon, pineapple, plum, pomegranate, quince, strawberry, tomato, eggplant, pepper, melon, cucumber, watermelon, pumpkin, squash, zucchini, cantaloupe, honeydew, nuts like almond, beech, butternut, brazil nut, candlenut, cashew, chestnuts, filbert, hickory, kola nut, pecan, macadamia, maya nut, paradise nut, pili nut, pistachio, walnut, edible legumes and vegetables, turfgrass, forage grass, forage legumes, ornamental plants, hardwood trees, shrubs, vines, forbs, wild flowers, herbs, and plantation crops.

16. The method of claim 1, wherein the plant is a genetically modified plant.

17. The method of claim 1, wherein the plant is not a genetically modified plant.

18. The method of claim 1, further comprising assessing crop injury by measuring one or more of stunting, thinning, lodging, defoliation, bleaching, chlorosis, necrosis (burn), and root malformation.

19. The method of claim 1, further comprising assessing crop injury by measuring one or more of plant biomass accumulation, plant height, measures of plant nutrients, chlorophyll fluorescence, measurements of light reflectance patterns of plant surfaces, transpiration, respiration, photosynthesis, and yield.

20. The method of claim 1, wherein an improvement in one or more of pest control, desirable plant growth and appearance, and levels of crop yield results from contacting the plant, plant part, soil, or soilless medium with the HYT plant ameliorant and the one or more pesticide and/or plant growth regulator.
